(19) United States
(12) Patent Application Publication
(10) Pub. No.: US 2013/0129289 A1
(43) Pub. Date: May 23, 2013

(54) CASE ASSEMBLY HAVING WICKING BARRIER

(71) Applicant: Carey S. ROLAND, Lake Wales, FL (US)

(72) Inventor: Carey S. ROLAND, Lake Wales, FL (US)

(21) Appl. No.: 13/300,182

(22) Filed: Nov. 18, 2011

(51) Int. Cl. G02B 6/44; H01B 7/00; B23K 31/02; H01B 3/44; B28B 1/30; B05D 5/12; H01B 3/00; H02G 15/04

(52) U.S. Cl. 385/102; 174/110 R; 174/113 R; 174/74 R; 174/76; 174/110 FC; 174/110 V; 264/154; 427/118; 228/176

(57) ABSTRACT

A cable assembly configured to prevent the wicking of fluid inside the cable assembly and method for producing same. The assembly includes at least one wire surrounded by an insulative wire jacket. A portion of the wire jacket is removed to expose a portion of the wire. The at least one wire is overmolded with a material that adheres to the wire jacket and the exposed portion of the wire, thereby preventing the wicking of fluid along the inside and outside surfaces of the wire jacket. Solder may be applied to the exposed portion of the wire, thereby providing a fluid barrier within the wire in instances in which the wire is stranded.

### BACKGROUND OF THE INVENTION

1. Field of the Invention

The present invention relates to electrical cable assemblies. In particular, the present invention relates to an electrical cable assembly for use in a fuel pump assembly, wherein the cable assembly is configured to prevent damage or malfunction resulting from fluid entering an end of the cable and wicking through the inside, or along the outside, of the cable conductor jackets.

2. Description of the Related Art

Generally, in any type of aircraft that incorporates a fuel pump, a fuel pump cable is used to provide power or control signals to the fuel pump. The cable may include a plurality of individual electrically conductive wires. The individual wires are typically covered with insulative material to provide electrical isolation between the wires, prevent injury, and to protect the wires from elements of their surrounding environment. For instance, the fuel pump cable has a first one of its ends (proximal end) connected to the fuel pump. That first end may be located inside the housing of the fuel pump motor, which can be sealed from the elements. A second end opposite the first end is located outside the fuel pump and, for instance, may be mounted to at terminal block. Consequently, that second end (distal end) of the cable is exposed to the elements. Connectors are provided at each end of the cable to allow for mating inside the fuel pump and at the terminal block. Cable leaving the pump side will feed through a conduit, exiting the fuel tank wall to allow wires to connect at external terminal block.

This typical configuration is susceptible to problems caused by fluid entering the cable at either of its ends. For example, fluid such as moisture from the air, ethylene glycol, jet fuel, or cleaning materials, may enter the distal end of the cable at the terminal block, or possibly even at a compromised seal at the pump side, a nick in the insulation, or at another juncture. Vibration or blowing of the cable may cause the fluid inside the cable to wick along the length of the cable (which can be approximately 17 feet) to the proximal end where it can enter the sealed fuel pump. Fluid inside the cable may then cause the fuel pump to fail due to shorting of the wires inside the cable, particularly in the areas where the wires are attached to the connectors. The fluid can also deteriorate the cable itself.

Accordingly, there is a need to prevent fluid from wicking along the length of a cable, subjecting the cable and its connections to potential failure. In particular, there exists a need for a device that effectively prevents fluid from wicking along a conductive wire, which is disposed inside an insulative material. Furthermore, there exists a need for a device that effectively prevents fluid from wicking along an outside surface of an insulative material, which surrounds a wire that is connected to an electrical device.

### SUMMARY AND OBJECTS OF THE INVENTION

Accordingly, it is an object of the invention to provide a cable assembly that is configured to prevent the wicking of fluid along conductive wires disposed in the cable assembly, wherein each wire is surrounded by an insulative jacket. It is another object of the invention to provide a cable assembly that is configured to prevent the wicking of fluid along outside surfaces of insulative jackets surrounding wires, wherein the wires are electrically connected to a connector.

Those and other objects and features of the present invention are further accomplished by an electrical cable assembly comprising: a cable having at least one conductive wire; an insulative wire jacket corresponding to each wire, each wire jacket surrounding the corresponding wire; a window disposed in each wire jacket such that a portion of the corresponding wire is exposed in the window; and an overmold adhering to each wire jacket to provide a fluid barrier between the overmold and the wire jacket, and adhering to each of the portions of wire exposed in each window to provide a fluid barrier between the overmold and each of the wires.

The electrical cable assembly may include one or more stranded conductive wires, in which case, the electrical cable assembly may include solder disposed in each window, the solder forming a fluid barrier in each stranded wire. The electrical cable assembly may include a connector having at least one mating contact, wherein each wire is electrically connected to a mating contact.

The above objects and features of the present invention are accomplished, as embodied and fully described herein, by a method of manufacturing an electrical cable assembly comprising the steps of: providing a cable having at least one wire; providing an insulative wire jacket for each wire, wherein each wire jacket surrounds a corresponding wire and includes a window at which a portion of the corresponding wire is exposed; and providing an overmold that surrounds each window and each wire jacket, thereby forming a fluid barrier that prevents the wicking of fluid along the inside and outside surfaces of each wire jacket. The method may include the step of applying solder to each of the exposed portions of wire, whereby the solder forms a fluid barrier.

With those and other objects, advantages, and features of the invention that may become hereinafter apparent, the nature of the invention may be more clearly understood by reference to the following detailed description of the invention, the appended claims, and the several drawings attached herein.

### BRIEF DESCRIPTION OF THE DRAWINGS

FIG. 1A is an exploded view of a cable assembly in accordance with an embodiment of the invention.

FIG. 1B is a cross-sectional view of a cable assembly in accordance with an embodiment of the invention showing potential leak paths and fluid barriers.

FIG. 1C is a front view of a cable assembly in accordance with an embodiment of the invention.

FIG. 2 is a perspective view of a cable in accordance with an embodiment of the invention showing the preparation of wires.

FIG. 3 is a perspective view of a cable in accordance with an embodiment of the invention showing the provision of stabilizer bushings.

FIG. 4 is a perspective view of a cable in accordance with an embodiment of the invention showing the provision of an overmold seal plug.

FIG. 5 is a perspective view of a cable and a connector in accordance with an embodiment of the invention showing the wires connected to a connector.

FIG. 6 is a perspective view of a cable and a connector in accordance with an embodiment of the invention showing the provision of an epoxy potting.

FIG. 7 is a perspective view of a cable and a connector in accordance with an embodiment of the invention showing the provision of a final overmold portion.

### DETAILED DESCRIPTION OF THE PREFERRED EMBODIMENTS

Several preferred embodiments of the invention are described for illustrative purposes, it being understood that the invention may be embodied in other forms not specifically shown in the drawings.

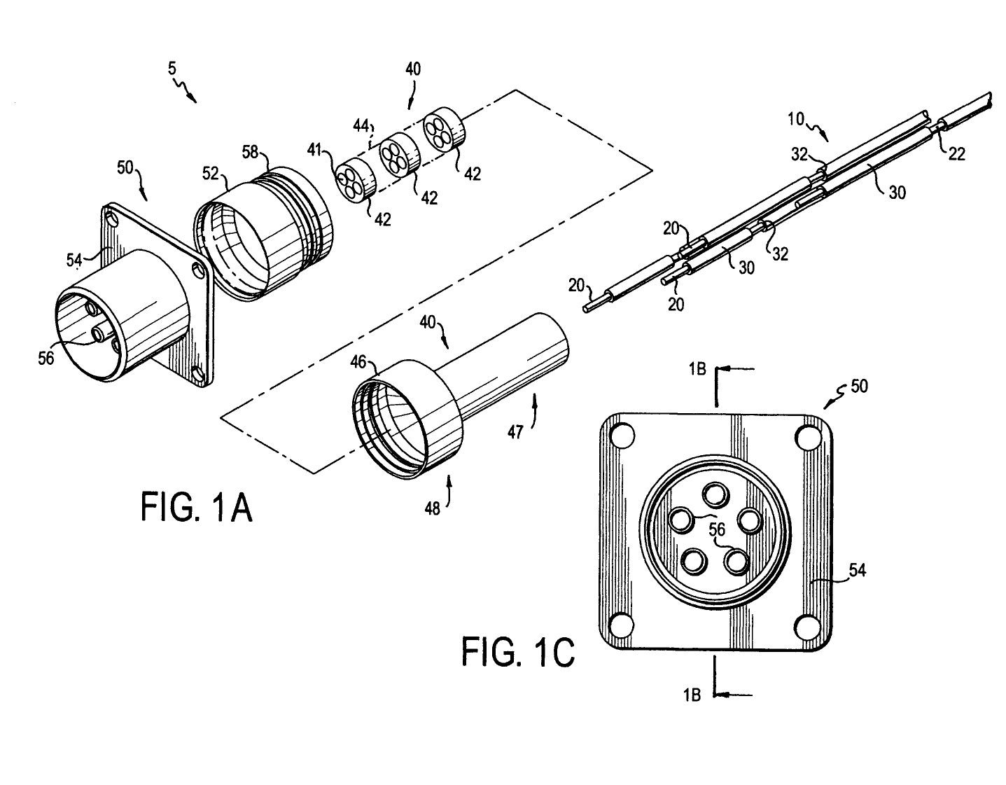

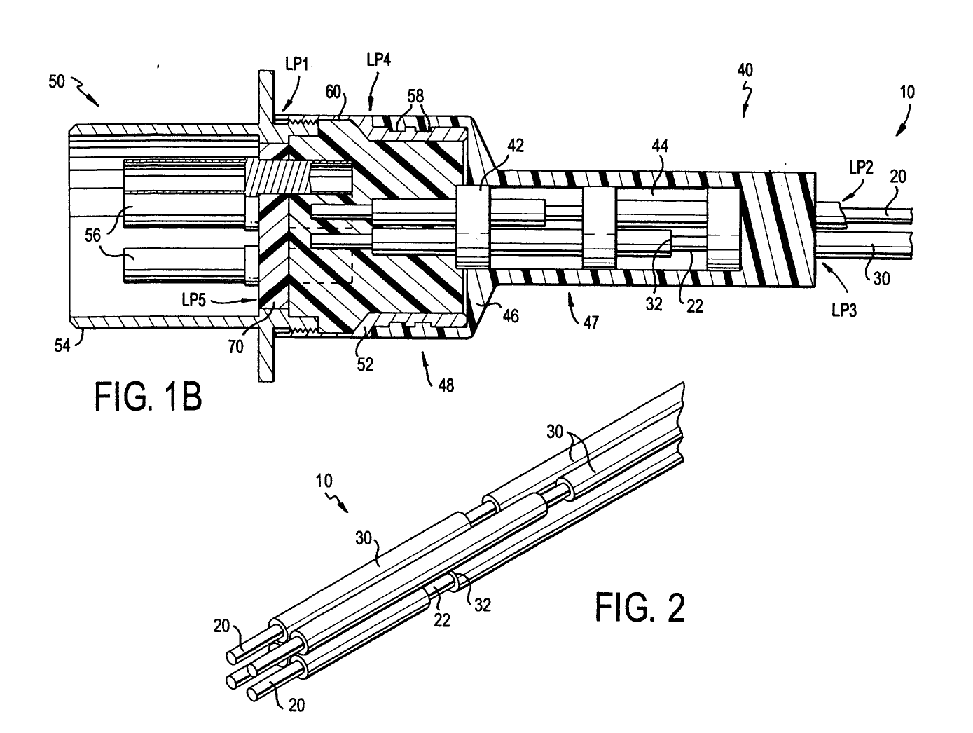

Turning first to FIGS. 1A-1C, FIG. 1A shows an exploded view of a cable assembly 5 in accordance with a preferred embodiment of the invention. FIG. 1B shows a lengthwise cross-sectional view of a portion of the cable assembly 5, the cross-section taken along the line 1B-1B in FIG. 1C. FIG. 1C shows a front view of the connector 50 viewed from its mating end. The remainder of the cable 10 is behind the connector 50 and therefore not visible in FIG. 1C.

With continued reference to FIGS. 1A-1C, the cable assembly 5 includes a cable 10, an overmold 40, and a connector 50. The cable 10 connects to the connector 50, and is covered by the overmold 40. The cable 10 includes wires 20 formed of electrically conductive material, and insulative wire jackets 30. Each individual wire 20 is surrounded by a wire jacket 30, which electrically isolates the wire from other wires 20 in the cable 10. The wire jackets 30 are formed of an insulative material, which protects and insulates the wires 20. Preferably, the wire jackets 30 are formed of Teflon, which is advantageous in high temperature applications. However. PVC or other types of insulative material may be used to form the wire jackets 30. The wires 20 have proximal and distal ends and intermediate portions therebetween. The tips of the proximal ends of the wires 20 are left exposed, without wire jackets 30, to electrically couple with the connector 50. FIG. 1A shows the cable 10 having four wires 20, however, the cable 10 may include more or less than four wires 20. The wires 20 may be solid (i.e. formed from a single solid wire), or may be stranded (i.e., formed from a plurality of individual wire strands). Preferably, the wires 20 are formed of nickel-plated copper. However, silver-plated copper, bare copper, or any other suitable wires 20 and conductive materials can be used.

At least one window 32 is formed in each wire jacket 30 at one or more points along the wire 20. The windows 32 are formed in the intermediate portion of the wire 20 by stripping all of the wire jacket 30 from the wire 20, completely around the wire 20. Accordingly, the wire jacket 30 is discontinuous at the window 32, and a portion of the wire 20 is exposed in the window 32. The windows 32 are staggered, such that the exposed portion of one wire 20 is not adjacent to the exposed portion of any other wire 20. Preferably, the windows 32 are staggered by a distance of at least 1 mm. When the windows 32 are staggered, the insulation resistance (distance) between the wires 20 remains the same as in instances in which the wires 20 are positioned side by side with jacket insulator spacing. The staggered window 32 configuration ensures that the wires 20 remain electrically isolated from one another, and prevents arcing between the wires 20. Preferably, each wire 20 has at least one window 32, which is located close to the connector 50, at a distance of about 0.675 inches from the end of the wire. However, more than one window 32 can be provided along each wire 20.

In the case in which the wires 20 are stranded, solder 22 is applied to the portions of the wires 20 exposed at each of the windows 32. Solder 22 flows into gaps or openings inherently present between strands of the wires 20 or present in defects in the wires 20. Thus, the addition of solder 22 causes the portion of stranded wire 20 exposed in the window 32 to become a solid piece, thereby forming a fluid barrier. Accordingly, the solder 22 prevents fluid from wicking along the length of the wire 20 inside the wire jacket 30. Any fluid present inside the wire jacket 30 will be unable to pass the fluid barrier formed by the solder 22. Preferably, the length of each window 32 is large enough so that soldering equipment is capable of applying adequate heat and solder 22 to the portions of the wires 20 exposed in each of the windows 32 (i.e., solder 22 must be capable of flowing to the center of the stranded wires 20 to provide a fluid barrier therein). Preferably, the length of the windows 32 is also minimized to reduce the amount of space required for the overmold 40 inside the fuel pump. In instances in which solid (unstranded) wires 20 are used, the invention does not require the application of solder 22 to the portions of wires 20 exposed in the windows 32.

The cable assembly 5 includes an overmold 40 that surrounds the wires 20, and the wire jackets 30 at the proximal end, and a portion of the intermediate portion, of the cable 10. The overmold 40 may be formed of any material that is capable of adequately adhering to the wire jackets 30 and the portions of the wires 20 exposed in the windows 32. For example, the overmold 40 may be formed of a rubber or plastic material, such as polyethylene or other thermoplastic or thermoset material. Viton is a preferred material for forming the overmold 40, because Viton has a high chemical resistance to ethylene glycol and jet fuel, and is suitable for high temperature applications. The overmold 40 is electrically insulative and provides added protection where the cable connects to the connector 50. The overmold 40 includes stabilizer bushings 42, an overmold seal plug 44, and a final overmold housing 46. Each of the bushings 42 is ring-shaped and includes openings 41, wherein each opening 41 accommodates an individual wire 20. The overmold seal plug 44 is cylindrical with a diameter approximately equal to that of the bushings 42. The overmold seal plug 44 includes the bushings 42 and additional molded material that tills the space between each of the bushings 42. The overmold seal plug 44 surrounds the wires 20, the windows 32, and the wire jackets 30. The overmold housing 46 has a sleeve 47 and a wide head 48, which may form one unitary piece. The sleeve 47 covers the overmold seal plug 44. Accordingly, the wires 20, the wire jackets 30, and the windows 32 are surrounded by the sleeve 47. The head 48 covers a portion of the connector 50, specifically, the connector adapter 52. The bushings 42, the overmold seal plug 44, and the overmold housing 46 form parts of the overmold 40 and are therefore formed from the same material as the overmold 40. The overmold 40 prevents fluid from entering the connector adapter 52 by preventing any fluid present in the cable assembly 5 from wicking along the outside surfaces of the wire jackets 30 at locations where the overmold 40 adheres to the wire jackets 30. The overmold 40 also prevents fluid from entering the connector adapter 52 by preventing any fluid present in the cable assembly 5 from wicking along the inside surfaces of the wire jackets 30 at locations where the overmold 40 adheres to the portions of the wires 20 exposed in the windows 32.

The cable assembly 5 includes a connector 50 disposed at the proximal end of the cable 10. The connector 50 can be any suitable connector, and one non-limiting illustrative connector is shown having a connector adapter 52, a connector receptacle 54, and mating contacts 56. The mating contacts may, for example, include solder cups or crimp contacts. The connector adapter 52 is cylindrical and capable of being removably attached to the connector receptacle 54, such as by a screwing process. The specific type of connector 50 employed may be selected based on the specific application for which the cable assembly 5 is desired. The connector 50 allows the cable 10 to interface with an appropriate device such as a fuel pump or a terminal block. Accordingly, each of the wires 20 may be electrically connected to mating contacts 56 provided by the connector 50. Preferably, the wires 20 are soldered to the mating contacts 56, which extend through the connector receptacle 54. A portion of each wire jacket 30 may be stripped from its surrounded wire 20 to allow the wire 20 to form a reliable electrical connection with the appropriate mating contact 56. A portion of the connector 50 may be surrounded by a portion of the overmold 40. Specifically, the overmold housing 46 may surround a portion of the connector adapter 52. A portion of the connector adapter 52 may include annular grooves 58 about its outer circumference. The grooves 58 on the connector adapter 52 engage mating grooves inside the head 48 of the overmold housing 46. The grooves 58 also increase the surface area of the connector adapter 52, resulting in improved adhesion between the connector adapter 52 and the overmold housing 46.

A preferred method for manufacturing the invention will now be discussed with reference to FIGS. 2-7. The method disclosed herein is provided as an example and is not intended to limit the scope of the invention. The steps of the method may be performed in an order different from the order disclosed herein without departing from the spirit and scope of the invention.

Turning to FIG. 2, electrically conductive wires 20 having wire jackets 30 are provided. The wire jackets 30 are provided by any appropriate means, such that each wire jacket 30 surrounds an individual wire 20. For instance, the wire jackets 30 may be formed by extrusion. Portions of the wire jackets 30 are cut and stripped from the wires 20 to form windows 32. Portions of the wire jackets 30 disposed at the proximal ends of the wires 20 may also be stripped to facilitate the connection of the wires 20 to the mating contacts 56 of the electrical connector 50.

In instances in which the invention includes stranded wires 20, following the formation of the windows 32, a flux is applied to the exposed portions of the wires 20. The flux removes the plating, or other corrosive migrates, on the stranded wires 20 and cleanses the wires 20 in preparation for the solder 22. The removal of the plating allows solder 22 to better penetrate the stranded wires 20 and bind to the wires 20. The liquid solder 22 is then applied to the exposed portions of the wires 20. The solder 22 may, for example, be applied manually with a soldering iron, or the application of solder 22 may be automated. The liquid solder 22 penetrates into the gaps between strands of the wires 20. The liquid solder 22 then cools and solidifies to form barriers that prevent any fluid that may be present inside the wire jackets 30 from wicking past the barriers formed by the solder 22. Each wire 20 is then a solid member comprising stranded wire and solder 22, where strands of each wire 20 are embedded in the solder 22. An x-ray or CT scan may be used, but is not required, to ensure that solder 22 has entered the gaps between the strands. In instances in which the invention includes wires 20 that are not plated, or are not stranded, the steps of providing flux or providing solder may be excluded without departing from the scope of the invention.

After the application of solder 22 to the wires 20 at the windows 32, a surface treatment is applied to the wire jackets 30. As the wire jackets 30 may be formed of Teflon, which is typically non-adhesive, the surface treatment allows the Teflon of the wire jackets 30 to adhere to the overmold 40. For example, the Teflon surfaces of the wire jackets 30 may be configured to accept adhesion by converting the surfaces of the wire jackets 30 with sodium naphthalene, thereby “etching” the surfaces of the wire jackets 30. In some instances, depending on the material used to form the wire jackets 30, application of a surface treatment to the wire jackets 30 may not be necessary to ensure adequate adhesion of the wire jackets 30 to the overmold 40.

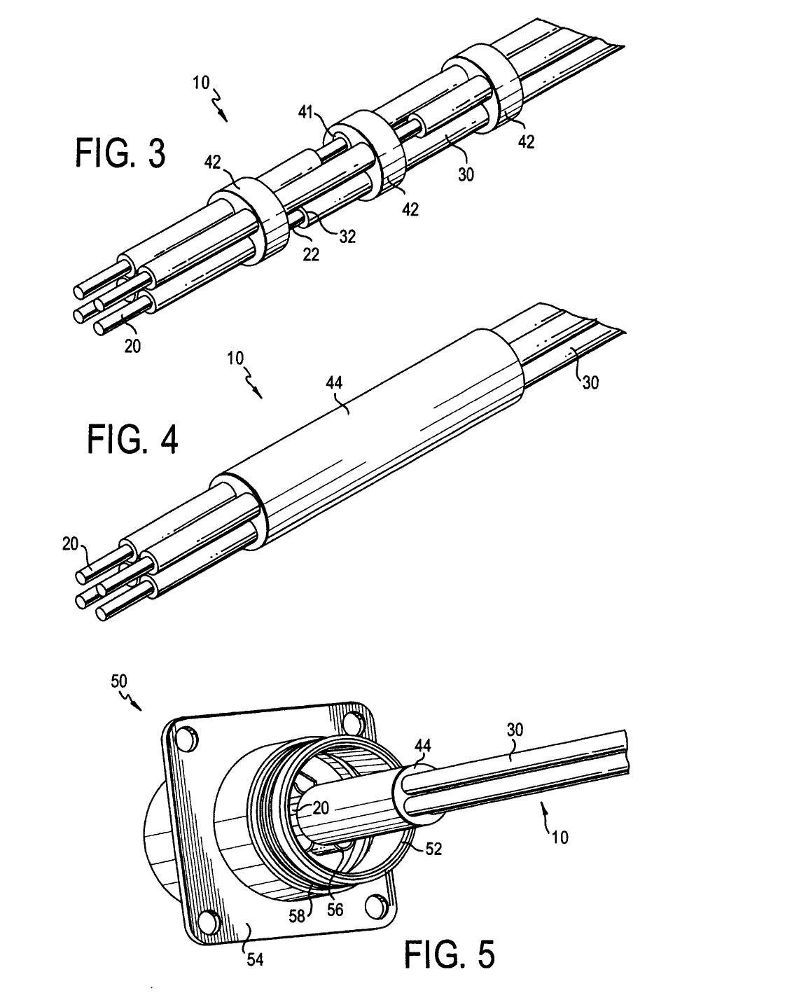

Turning to FIG. 3, bushings 42 are provided about the cable 10. Preferably, the bushings 42 are molded prior to their installation in the cable assembly 5. The wires 20 and wire jackets 30 may be slidably inserted into openings 41 in the bushings 42. The insertion of the wires 20 and wire jackets 30 into the bushings 42 may be performed manually, or may be automated. Preferably, three bushings 42 are provided, although the method may be performed using more or less than three bushings 42. The bushings 42 are provided spaced from one another. To ensure a snug fit between the bushings 42 and the wire jackets 30, the bushings 42 are not aligned with the windows 32. The bushings 42 maintain the wires 20 at predetermined positions with respect to each other in the mating interface between the cable 10 and the connector 50. The bushings 42 hold the wires 20 in place during the subsequent overmolding step. A fixture (not shown) may be used to assist with the proper placement of the bushings 42, the wires 20, and the wire jackets 30 during the subsequent overmolding step.

FIG. 4 illustrates the initial overmolding step. During the initial overmolding step, the overmold seal plug 44 surrounds the wires 20 and wire jackets 30, and the bushings 42 and the overmold seal plug 44 adhere to the surfaces of the wire jackets 30 and the exposed portions of the wires 20. The overmold seal plug 44 and the bushings 42, collectively, cover all of the solder 22 and the portions of the wires 20 exposed in the windows 32. The overmold seal plug 44 forms a part of the overmold 40 and is therefore formed from the same material as the overmold 40, preferably Viton. The overmold seal plug 44 provides a seal that prevents fluid that may be present in the cable assembly 5 from wicking past the overmold seal plug 44 along the outsides of the wire jackets 30. The overmold seal plug 44 also provides a seal that prevents fluid that may be present in the cable assembly 5 from wicking along the insides of the wire jackets 30 past the windows 32, at which the overmold seal plug 44 adheres to portions of the wires 20. Preferably, during the initial overmolding step, the portion of the cable 10 having the windows 32 and bushings 42 is loaded into a mold, and the overmold material flows into the mold cavity to form the cylindrical seal plug 44. All of the molding steps described herein are preferably performed as a transfer molding process with Viton material. However, other molding techniques may be used without departing from the scope of the invention.

FIG. 5 shows the step of the manufacturing method in which the wires 20 are electrically connected with the mating contacts 56 of the connector 50. The wires 20 can be received in or connected to the mating contacts 56 of the connector 50 by any appropriate means, such as by soldering, adhesion, crimp, or press tit.

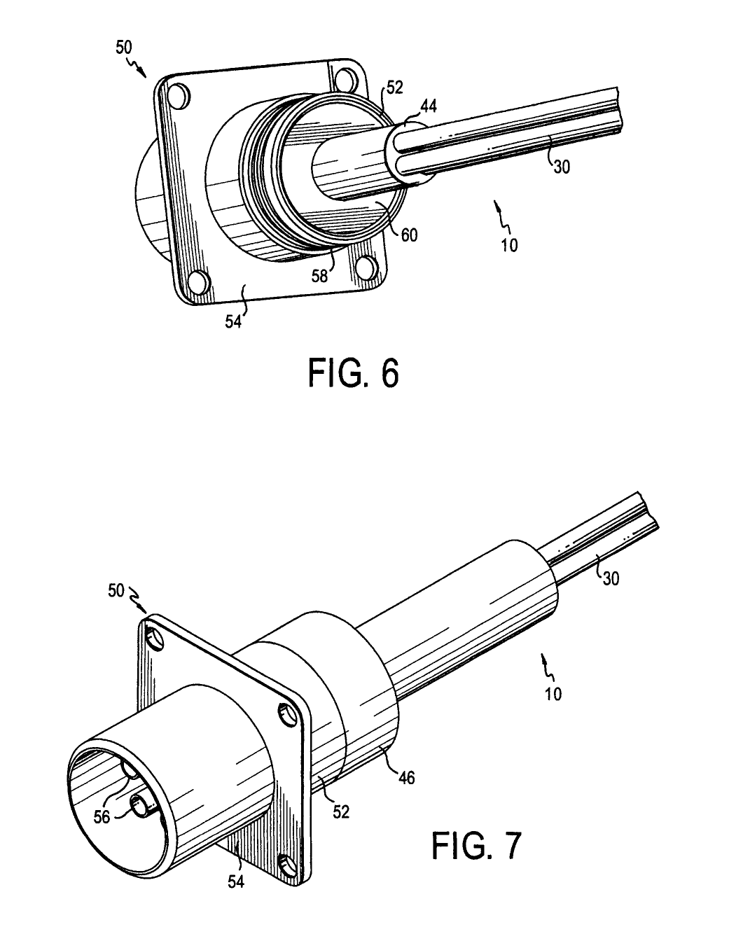

FIG. 6 shows the cable assembly 5 with an epoxy potting 60, which is provided to form an environmental seal inside the connector 50 where the wires 20 contact the mating contacts 56. The epoxy potting 60 may completely till the remaining inside volume of the connector adapter 52. The epoxy potting 60 prevents fluid from entering the connector 50 and shorting the mating contacts 56.

FIG. 7 shows the cable assembly 5 with an overmold housing 46, which is added to further seal off the connector 50. The overmold housing 46 covers the epoxy potting 60, and surrounds the overmold seal plug 44 and a portion of the connector adapter 52, including the grooves 58. The material used to form the overmold housing 46 forms into the grooves 58 of the connector adapter 52. The material used to form the overmold housing 46 may enter the mold in a molten state for ease of filling and processing.

Typically, fluid that contacts only an individual wire 20 inside a wire jacket 30 will not cause a cable assembly 5 to fail. Accordingly, a significant amount of cable failures typically result from short circuits caused by fluids reaching the insides of connectors 50, wherein multiple mating contacts 56 are present and fluid may conduct across mating contacts 56, a condition known as arcing. Therefore, the solder 22 in the windows 32 serves the important purpose of preventing fluid from reaching the connector 50 by wicking along the wires 20 in instances in which the wires 20 are stranded, and the overmold 40 serves the important purpose of preventing fluid from reaching the connector 50 by wicking along the insides and the outsides of the wire jackets 30.

Turning back to FIG. 1B, shown therein are five potential leak paths LP1-LP5, or interfaces through which fluid may intrude and cause failure of the cable assembly 5. Also shown in FIG. 1B are features of the present invention that prevent fluid intrusion through each of those leak paths LP1-LP5.

The first potential leak path LP1 is located between the connector adapter 52 and the connector receptacle 54. An epoxy potting 60 provides a barrier to any fluid that might intrude via the first potential leak path LP1. A sealant, such as Loctite 272 may be applied between the connector adapter and the connector receptacle to provide an additional fluid seal along LP1.

The second potential leak path LP2 is located inside each wire jacket 30. To prevent fluid from wicking along an inside surface of the wire jacket 30 and reaching the connector 50, windows 32 are disposed in each wire jacket 30, and the overmold 40, specifically the seal plug 44, adheres to the portions of conductive wire 20 exposed in each window 32. If fluid wicks from the distal end of the cable 10 along the second potential leak path LP2, upon the fluid reaching the window 32, the overmold 40, specifically the seal plug 44, directs the fluid away from the connector 50. In instances in which the wire 20 is a stranded wire, solder 22 provided in each of the windows 32 penetrates the gaps between the wire strands and provides a barrier to any fluid that might intrude via the second potential leak path LP2. If fluid wicks from the distal end of the cable 10 along the second potential leak path LP2, the solder 22 stops the fluid and the fluid may move to the outside of the wire 20, where the overmold 40, specifically the seal plug 44, directs the fluid away from the connector 50. The windows 32, which may include the solder 22 are located close to the connector 50 and covered by the overmold 40 to capture all wicking.

The third potential leak path LP3 is located between the overmold 40 and the outsides of the wire jackets 30. The adhesion of the overmold 40, specifically the seal plug 44, to the solder 22 and wire jackets 30 provides a barrier to any fluid that might intrude via the third potential leak path LP3.

The fourth potential leak path LP4 is located between the overmold 40 and the connector adapter 52. Portions of the overmold 40 surrounding the grooves 58 in the adapter connector 52, and the epoxy potting 60, either alone or in combination, may provide a barrier to any fluid that may intrude via the fourth potential leak path LP4.

The fifth potential leak path LP5 is through the mating end of the connector 50. The ceramic insert 70, which forms a hermetic seal in the connector 50, provides a barrier to any fluid that may intrude via the fifth potential leak path LP5.

It is envisioned that the present invention will be particularly useful as a fuel pump cable on various types of aircrafts that include fuel pump assemblies. However, the present invention is not limited to a specific application. The present invention may be used, for example, in any high voltage application in which it is desirable to protect wires or connectors from exposure to environmental elements, or in which diesel fuels or other harsh chemicals are present. The present invention is capable of functioning in instances in which it is completely saturated with any fluid. The invention is capable of functioning over a range of temperatures from −50° C. to 200° C.

The invention is not limited to instances in which windows 32 are positioned proximate to the connector 50, or in which the overmold 40 physically contacts the connector 50. Rather, windows 32 having exposed portions of wire 20, in which solder 22 may form a fluid barrier, may be positioned at any point along each wire 20. One or more seal plugs 44 may be provided, the seal plugs 44 surrounding the wire jackets 30, and adhering to the wire jackets 30 and the portions of wire 20 exposed in each window 32. The overmold 40 may include an overmold housing 46, which is provided after the provision of the seal plug 44. However, the overmold 40 is not required to include an overmold housing 46.

In an alternative embodiment of the invention, windows 32 having exposed portions of wire 20, in which solder 22 may form a fluid barrier may be positioned at several different locations along the length of the each wire 20. One or more seal plugs 44 may be provided, the seal plugs 44 surrounding the wire jackets 30, and adhering to the wire jackets 30 and the portions of wire 20 exposed in each window 32.

In yet another alternative embodiment of the invention, the wires 20 may be formed of optical fibers rather than electrically conductive material. In such an embodiment, the overmold seal plug 44 adheres to portions of the fiber optic wires 20 exposed in windows 32, and provides a barrier to fluid that wicks along the inside surfaces of the wire jackets 30, between the wire jackets 30 and the fiber optic wires 20.

Although certain presently preferred embodiments of the disclosed invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extent required by the appended claims and the applicable rules of law.

What is claimed is:

1. An electrical cable assembly comprising:
a cable having at least one conductive wire;
an insulative wire jacket surrounding each wire;
a window disposed in each wire jacket such that a portion of the wire is exposed at the window; and
an overmold surrounding each window and at least a portion of each wire jacket,
wherein the overmold adheres to each wire jacket and to the portion of each wire exposed in each window.

2. The electrical cable assembly of claim 1 further comprising a plurality of wires.

3. The electrical cable assembly of claim 2, wherein the windows are arranged in a staggered configuration.

4. The electrical cable assembly of claim 1, wherein each wire comprises a plurality of individual wire strands.

5. The electrical cable assembly of claim 4 further comprising solder disposed in each window about the wire strands, the solder forming a fluid barrier in the wire.

6. The electrical cable assembly of claim 1 further comprising a connector, wherein the overmold surrounds a portion of the connector.

7. The electrical cable assembly of claim 6, wherein the portion of the connector surrounded by the overmold has an outside surface with grooves disposed thereon.

8. The electrical cable assembly of claim 6, wherein the connector further includes at least one mating contact, and wherein each wire is electrically connected to a mating contact.

9. The electrical assembly or claim 8, wherein the connector further includes an epoxy potting disposed therein, the epoxy potting forming a fluid barrier inside the connector.

10. The electrical cable assembly of claim 1, wherein each wire comprises nickel-plated copper.

11. The electrical cable assembly of claim 1, wherein each wire comprises silver-plated copper.

12. The electrical cable assembly of claim 1, wherein each wire jacket comprises Teflon.

13. The electrical cable assembly of claim 1, wherein each wire jacket comprises PVC.

14. The electrical cable assembly of claim 1, wherein the overmold comprises a thermoplastic or thermoset material.

15. The electrical cable assembly of claim 1, wherein the overmold comprises Viton.

16. The electrical cable assembly of claim 1, wherein the electrical cable assembly is configured to be used in a fuel pump assembly.

17. A method of manufacturing an electrical cable assembly comprising the steps of:
providing a cable having at least one conductive wire;
providing an insulative wire jacket for each wire, wherein each wire jacket surrounds a corresponding wire;
providing at least one window in each wire jacket, wherein a portion of the corresponding wire is exposed in each window; and
providing an overmold seal plug,
wherein the overmold seal plug surrounds each window and at least a portion of each wire jacket,
and wherein the overmold seal plug adheres to each wire jacket and to the portion of each wire exposed in each window.

18. The method of claim 17, wherein each window is formed by cutting and stripping a portion of the wire jacket.

19. The method of claim 17, further comprising the step of providing a plurality of wires.

20. The method of claim 19, wherein the windows are arranged in a staggered configuration.

21. The method of claim 17, wherein each wire comprises a plurality of individual wire strands.

22. The method of claim 21 further comprising the step of applying solder to the exposed portion of each wire, wherein the solder forms a fluid barrier in the wire.

23. The method of claim 22 further comprising the step of applying a flux to the exposed portion of each wire prior to applying solder to the exposed portion of each wire.

24. The method of claim 17 further comprising the step of surface treating each wire jacket to promote adhesion of each wire jacket to the overmold seal plug.

25. The method of claim 17 further comprising the step of inserting the wires into bushings prior to providing the overmold seal plug.

26. The method of claim 17, wherein each wire comprises nickel-plated copper.

27. The method of claim 17, wherein each wire comprises silver-plated copper.

28. The method of claim 17, wherein each wire jacket comprises Teflon.

29. The method of claim 17, wherein each wire jacket comprises PVC.

30. The method of claim 17, wherein the overmold seal plug comprises a thermoplastic or thermoset material.

31. The method of claim 17, wherein the overmold seal plug comprises Viton.

32. The method of claim 17 further comprising the steps of providing a connector having at least one mating contact; and
electrically connecting each wire to a mating contact.

33. The method of claim 32 further comprising the steps of providing an epoxy potting inside the connector, wherein the epoxy potting forms a fluid barrier inside the connector.

34. The method of claim 32 further comprising the step of providing an overmold housing, wherein the overmold housing surrounds the overmold seal plug and a portion of the connector.

35. The method of claim 34, wherein the overmold housing comprises a thermoplastic or thermoset material.

36. The method of claim 34, wherein the overmold housing comprises Viton.

37. A fiber optic cable assembly comprising:
a cable having at least one fiber optic wire;
an insulative wire jacket surrounding each wire;
a window disposed in each wire jacket such that a portion of the wire is exposed at the window; and
an overmold surrounding each window and at least a portion of each wire jacket,
wherein the overmold adheres to each wire jacket and to the portion of each wire exposed in each window.

38. A method of manufacturing a fiber optic cable assembly comprising the steps of:
providing a cable having at least one fiber optic wire;
providing an insulative wire jacket for each wire, wherein each wire jacket surrounds a corresponding wire and includes a window at which a portion of the corresponding wire is exposed; and
providing an overmold seal plug,
wherein the overmold seal plug surrounds each window and at least a portion of each wire jacket,
and wherein the overmold seal plug adheres to each wire jacket and to the portion of each wire exposed in each window.
